(19) United States
(12) Patent Application Publication
(10) Pub. No.: US 2025/0003559 A1
(43) Pub. Date: Jan. 2, 2025

(54) PORTABLE AREA LIGHT

(71) Applicant: MILWAUKEE ELECTRIC TOOL CORPORATION, Brookfield, WI (US)

(72) Inventors: Jonathan Kuta, Milwaukee, WI (US); Andrew C. Wells, Milwaukee, WI (US); Jeremy A. Schmittinger, Waukesha, WI (US); Jeffrey L. Spenner, Germantown, WI (US); Matthew J. Johnson, Oconomowoc, WI (US); Megan N. Wasmer, Oak Creek, WI (US)

(21) Appl. No.: 18/758,798

(22) Filed: Jun. 28, 2024

Related U.S. Application Data
(60) Provisional application No. 63/510,746, filed on Jun. 28, 2023.

(51) Int. Cl. F21S 6/00; F21S 9/02; F21V 21/06; F21V 21/22; F21V 21/30; F21V 21/40; F21W 131/10; H05B 47/11

(52) U.S. Cl. CPC F21S 6/006; F21S 9/02; F21V 21/06; F21V 21/22; F21V 21/30; F21V 21/40; H05B 47/11; F21W 2131/1005

(57) ABSTRACT

An area light includes a base having a first end and a second end, a pair of legs rotatably coupled to the first end of the base, wherein the pair of legs is rotated towards the base when the area light is in a stowed configuration and is rotated away from the base when the area light is in an open configuration, and a light body having a mast and a light head coupled to the mast. The light body is rotatably coupled to the base on the first end of the base. The light body is rotated towards the base when the area light is in the stowed configuration and is rotated away from the base when the area light is in the open configuration.

### CROSS-REFERENCE TO RELATED APPLICATIONS

This application claims priority to U.S. Provisional Patent Application No. 63/510,746, filed on Jun. 28, 2023, the entire contents of which is incorporated herein by reference.

### BACKGROUND

The present invention relates to area lights, and more specifically, to portable area lights.

Mobile light systems, including area lights, are used to illuminate worksites or other areas without permanent lighting fixtures, outdoor spaces, and/or spaces without electricity. These worksites are often at remote locations, requiring the area lights to be transported to the worksite. Similarly, the worksites may be in a location where vehicles cannot easily maneuver, requiring the area light to be carried to the worksite by an operator. Many portable lights, such as handheld flashlights or small lantern style lights, are easy to carry to the worksites, but do not provide enough light to illuminate the area well enough to provide suitable working conditions. Other larger lights provide sufficient lighting to the worksite but may be cumbersome to transport.

### SUMMARY

In one embodiment, the invention provides an area light including a base having a first end and a second end; a pair of legs rotatably coupled to the first end of the base, and a light body having a mast and a light head coupled to the mast. The pair of legs is rotated towards the base when the area light is in a stowed configuration and is rotated away from the base when the area light is in an open configuration. The light body is rotatably coupled to the base on the first end of the base and is rotated towards the base when the area light is in the stowed configuration and is rotated away from the base when the area light is in the open configuration.

In some aspects, the mast includes a plurality of telescoping members configured to extend and retract the mast along a mast axis. Each telescoping member has a rectangular profile when viewed along the mast axis.

In some aspects, each telescoping member of the plurality of telescoping members has an adjustment assembly that selectively locks the telescoping member to an adjacent telescoping member.

In some aspects, the adjustment assembly includes a cuff having a rectangular profile and a cam latch rotatably coupled to the cuff for movement between a locked position and an unlocked position. In the locked position the cam latch clamps the cuff and moves the cuff into engagement with the adjacent telescoping member to prevent movement of the adjacent telescoping member along the mast axis.

In some aspects, the adjustment assembly includes a cuff and a friction lever rotatably coupled to the cuff between a locked position and an unlocked position. In the locked position the adjustment assembly prevents the adjacent telescoping member from moving with respect to the adjustment assembly. In some aspects, movement of the adjacent telescoping member in a first direction along the mast axis moves the friction lever to the unlocked position and movement of the adjacent telescoping member in a second direction along the mast axis, opposite the first direction, moves the friction lever to the locked position. In some aspects, the friction lever is manually held in the unlocked position to allow movement of the adjacent telescoping member in the second direction.

In some aspects, the light head includes a light source configured to emit light in a light distribution. In some aspects, the light distribution includes more light emitted toward a first side than emitted toward a second side. In some aspects most of the light distribution is positioned in front of the light head. In some aspects, all of the light distribution is positioned below the light head.

In some aspects, the area light also includes a controller configured to control the light source. In some aspects, the controller is configured to control a brightness of the light source using analog current control.

In some aspects, the area light also includes a latch assembly configured to retain the mast in the open configuration and a stop member that biases the mast toward the stowed configuration. In the open configuration the mast is secured between the stop member and the latch assembly to improve stability of the mast.

In another embodiment an area light is described. The area light includes a base having a first end and a second end and a pair of legs that are rotatably coupled to the first end of the base. The pair of legs are rotated towards the base when the area light is in a stowed configuration and are rotated away from the base when the area light is in an open configuration. The area light further includes a light body having a mast and a light head coupled to the mast. The light body is rotatably coupled to the base on the first end of the base and includes a light source. The area light also includes a light driver module that is configured to control the light source using analog current control.

In one aspect, the area light also includes a user interface that is configured to receive an input indicating a desired brightness and generate a brightness output associated with the received input.

In another aspect, the area light further includes a controller that is configured to receive the brightness output and provide a brightness control signal to the light driver module.

In another aspect, the area light includes an analog control circuit that is configured to receive the brightness output and generate a brightness control signal based on the received. The analog control circuit is further configured to provide the generated brightness control signal to the light driver module.

In another aspect, the analog control circuit is an RC circuit.

In another aspect, the light source includes a plurality of LEDs.

In another aspect, the analog current control uses a DC current to control the brightness of the light source.

Other aspects of the invention will become apparent by consideration of the detailed description and accompanying drawings.

### BRIEF DESCRIPTION OF THE DRAWINGS

FIG. 1 is a perspective view of a compact area light in a storage configuration.

FIG. 2 is a perspective view of the light of FIG. 1 in an open configuration with a mast partially extended.

FIG. 3 is a side view of the light of FIG. 1 in a further open configuration with the mast fully extended.

FIG. 4 is a perspective view of a base of the light of FIG. 1 with a light body including the mast removed.

FIG. 5 is a lower perspective view of the base of FIG. 4.

FIG. 6 is a sectional view of the base of FIG. 4 showing a battery installed in a battery receptacle.

FIG. 7 illustrates a latch assembly of the light of FIG. 1.

FIG. 8 illustrates an adjustment assembly for securing the mast of the light of FIG. 1.

FIG. 9 is a top view of the light of FIG. 2 in the open configuration.

FIG. 10 is a side view of the light of FIG. 2 in the open configuration.

FIG. 11 is a side view of a light distribution created by the light of FIG. 1 in the further open configuration.

FIG. 12 is a top view of the light distribution created by the light of FIG. 1 in the further open configuration.

FIG. 13 is a front view of a light distribution created by the light of FIG. 1 in the further open configuration.

FIG. 14 illustrates an additional embodiment of an adjustment mechanism for use with the mast of the light of FIG. 1, the adjustment mechanism in an unlocked position.

FIG. 15 illustrates the adjustment mechanism of FIG. 14 in a locked position.

FIG. 16 is a block diagram illustrating a control system of the light of FIG. 1, according to some embodiment.

FIG. 17 is a block diagram illustrating an alternative control system of the light of FIG. 1, according to some embodiments.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

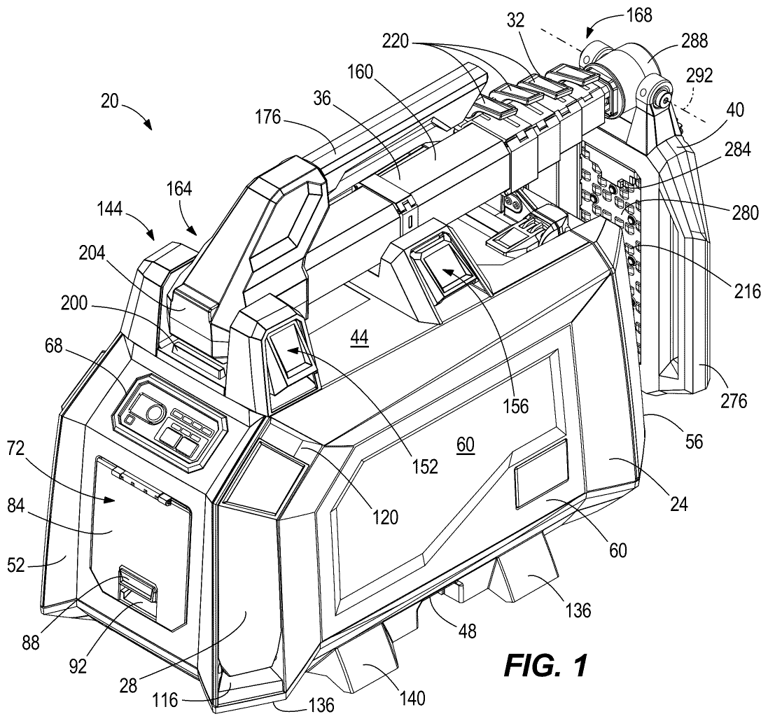

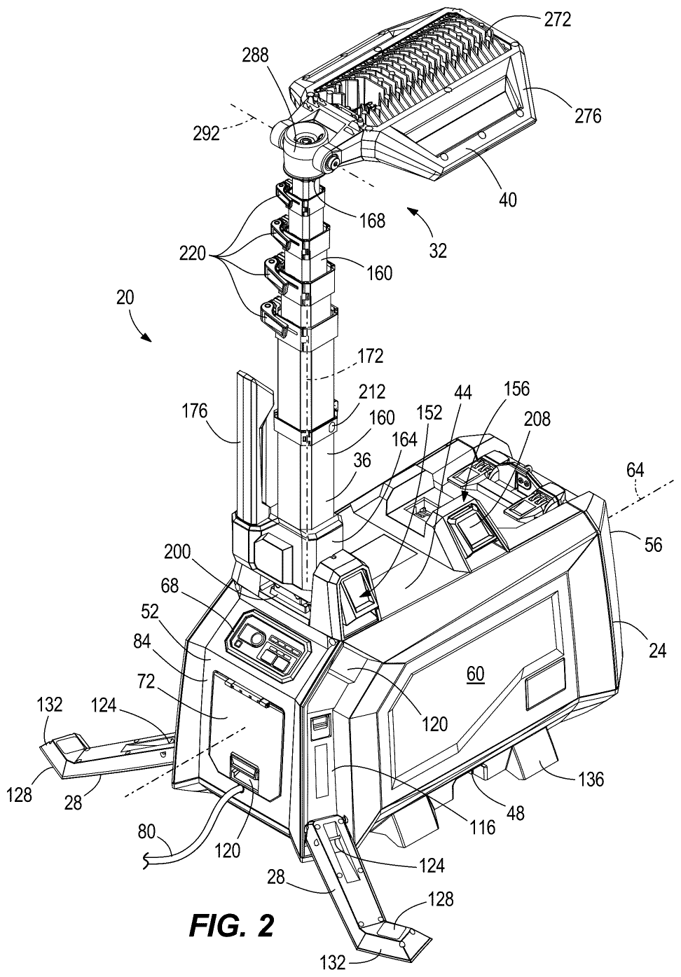

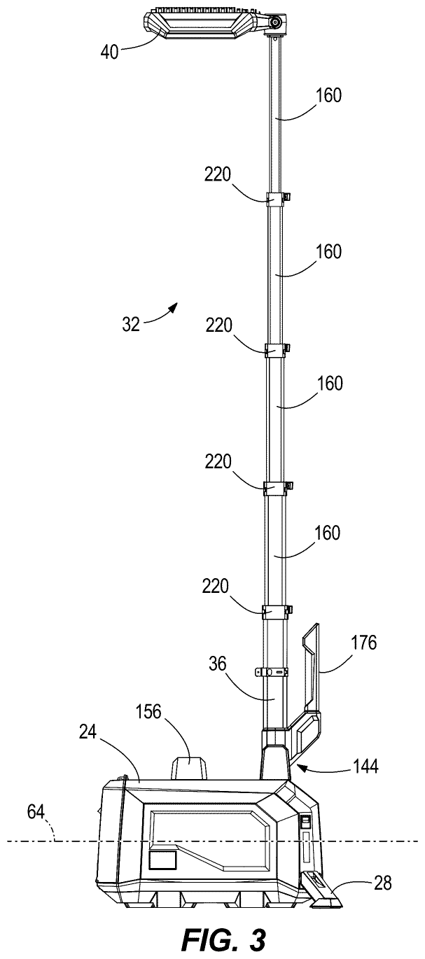

FIGS. 1-3 illustrate an area light 20 (also referred to herein as a work light 20) including a base 24, a pair of legs 28, and a light body 32 having a mast 36 and a light head 40. The legs 28 and the light body 32 are all rotatably connected to the base 24. As explained in greater detail below, the work light 20 may be converted between a stowed configuration (FIG. 1) and one or more open or expanded configurations (FIGS. 2 and 3). When in the open configuration, the light head 40 is supported above a ground or a surface to provide light to the area. When in the stowed configuration, the work light 20 is compact and transportable (e.g., carriable) through a worksite.

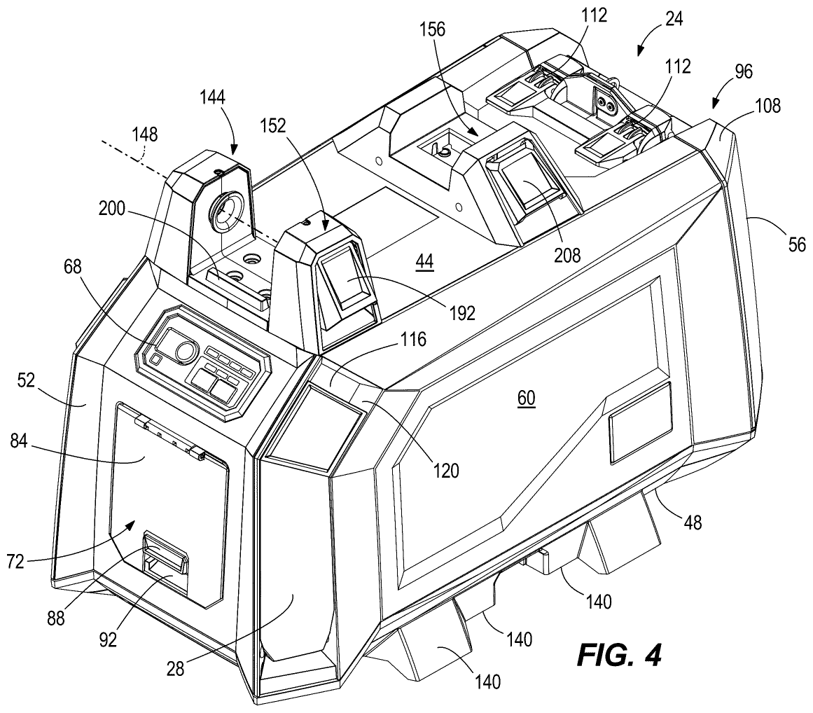

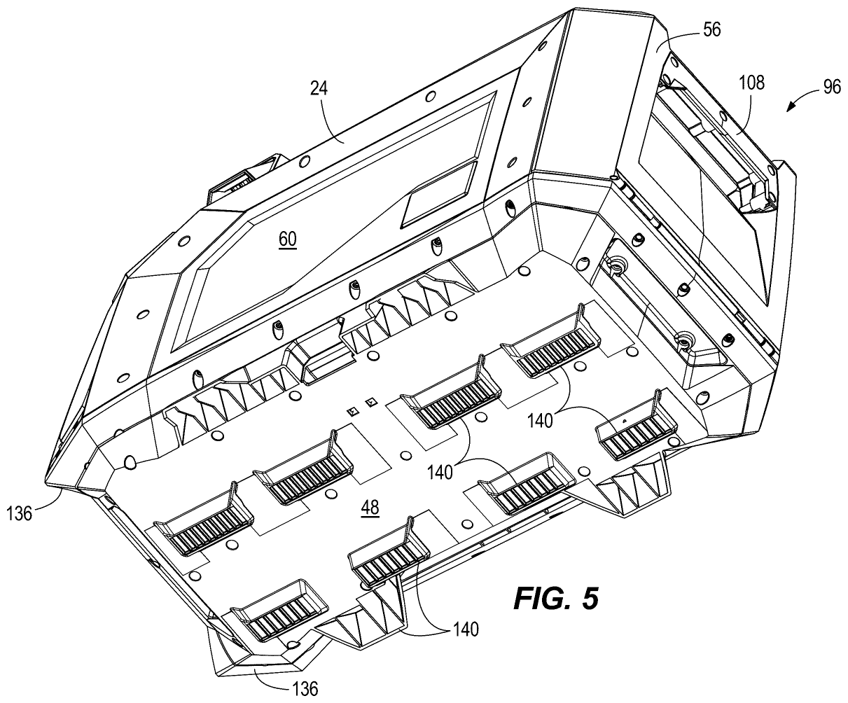

FIGS. 4-5 illustrate the base 24 with the light body 32 removed. The base 24 includes a top end 44, a bottom end 48, a front 52 (or first end), a back 56 (or second end), and sides 60 that are spaced apart from one another. The top end 44 and the bottom end 48 are spaced apart from one another and each spans the distance between the sides 60. The front 52 and back 56 extend between the top end 44 and the bottom end 48 and are spaced apart along a longitudinal axis 64.

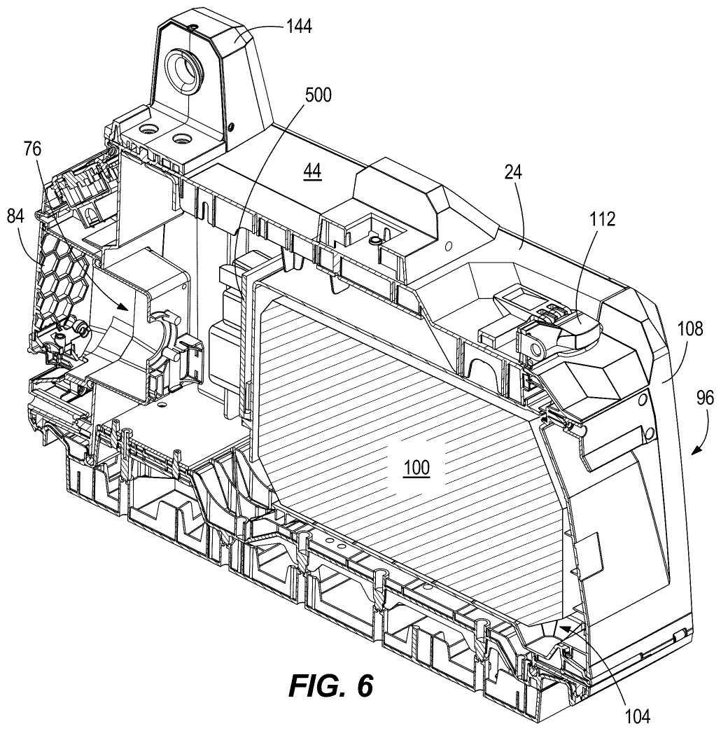

Additionally, the base 24 houses electrical components and other components of the work light 20. A controller 500 (FIG. 6) is disposed within the base 24. A user interface 68 is positioned on the outside of the base 24 and is in communication with the controller 500 to control the operation of the work light 20. The user interface 68 may include any number of controls (real or virtual) including but not limited to a power button, a brightness control, a charge indicator, a mode adjustment button, or various other controls. The user interface 68 may further include a display for displaying one or more parameters of the work light 20. In other examples, the display may be a touch screen display allowing for user inputs to be provided via the display. In the illustrated embodiment, the user interface 68 is positioned on the front 52 of the base 24 adjacent the top end 44; however, in other embodiments, the user interface 68 may be located on another portion of the base 24, on the light body 32, or any other location accessible to an operator. In the illustrated embodiment, the user interface 68 is accessible to an operator both when the work light 20 is in the open configurations and in the stowed configuration.

The work light 20 may optionally be powered by a DC power source (for example, one or more batteries) or may be connected to an external power supply (e.g., an AC power source). The base 24 includes a cord compartment 72. In the illustrated embodiment, the cord compartment 72 is positioned on the front 52 of the base 24. In other embodiments, the cord compartment 72 may be disposed in other locations of the base 24. The cord compartment 72 includes a cord receptacle 76 having electrical connections for engaging with a power cord 80 and a first cover 84 that is rotatable between an open position and a closed position. A cover latch 88 locks the first cover 84 in the closed position. In the illustrated embodiment, the first cover 84 is hingedly connected so the first cover 84 opens upward towards the user interface 68. The cover latch 88 is positioned at the bottom of the first cover 84. In the illustrated construction, the cover latch 88 is positioned in a cutout 92 of the first cover 84. When the power cord 80 couples the work light 20 to the external power supply, the power cord 80 extends through the cutout 92 while the first cover 84 is locked in the closed position by the cover latch 88. When the work light 20 is not connected to the external power supply, the power cord 80 may be stored in the cord compartment 72.

Referring to FIGS. 5 and 6, the base 24 also includes a battery compartment 96 for receiving the battery 100. In the illustrated embodiment, the battery compartment 96 is positioned on the back 56 of the base 24. In other embodiments, the battery compartment 96 may be disposed in other locations of the base 24. The battery compartment 96 includes a battery receptacle 104 having electrical connections for engaging with the battery 100 and a second cover 108 that is rotatable between an open position and a closed position. A battery latch 112 locks the second cover 108 in the closed position. In the illustrated embodiment, the second cover 108 is hingedly connected adjacent the bottom of the base 24 and the battery latch 112 is positioned on the top end 44 of the base 24. In the illustrated construction, the battery compartment 96 is arranged to receive at least one power tool battery pack as the battery 100. However, other constructions may include compartments arranged for different types of batteries or more or fewer batteries as may be required.

With reference to FIGS. 2 and 4, the base 24 includes a leg cradle 116 for each leg 28. The leg cradles 116 are sized and shaped to receive the legs 28. In the illustrated embodiment, the legs 28 are received in the leg cradles 116 so that a notch 120 (e.g., a portion of the leg cradle 116) is formed adjacent the stowed leg 28. The notch 120 allows an operator to easily access the legs 28 to move the legs 28 to the open configuration. The leg cradles 116 are positioned on each side 60 of the base 24 adjacent the front 52. When the legs 28 are in the stowed configuration, the legs 28 fit generally within the perimeter or footprint of the base 24.

The legs 28 are elongated and each include a proximal end 124 that is coupled to the base 24 and a distal end 128 that is spaced apart from the proximal end 124. In the illustrated embodiment, the proximal ends 124 of the legs 28 are coupled to the sides 60 of the base 24 and are positioned closer to the bottom end 48 of the base 24 than the top end 44. The distal ends 128 are rotatable towards and away from the base 24 to convert between the stowed configuration and the open configuration. Each distal end 128 of the legs 28 includes a foot 132, which is positioned against the ground to support the work light 20 in the open configurations.

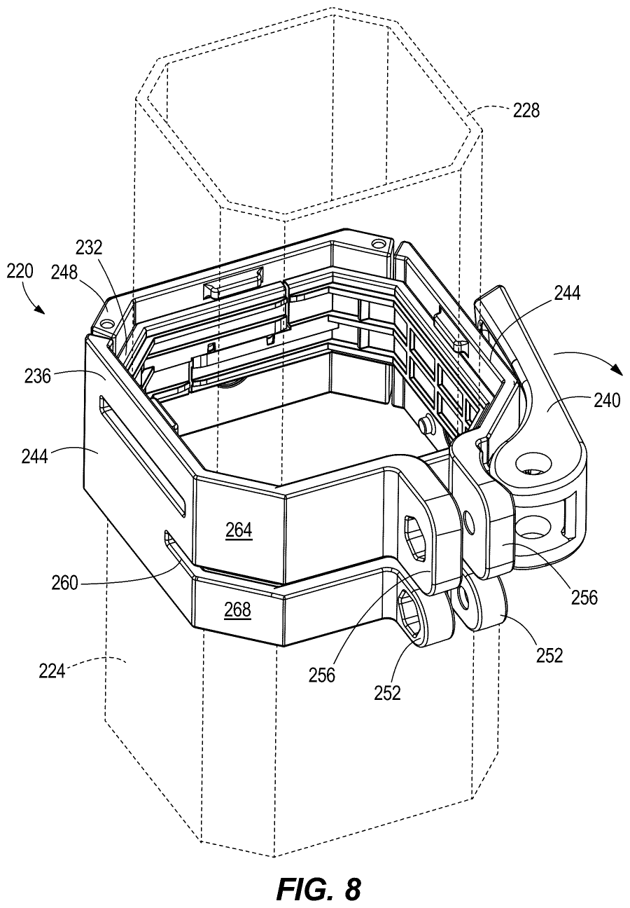

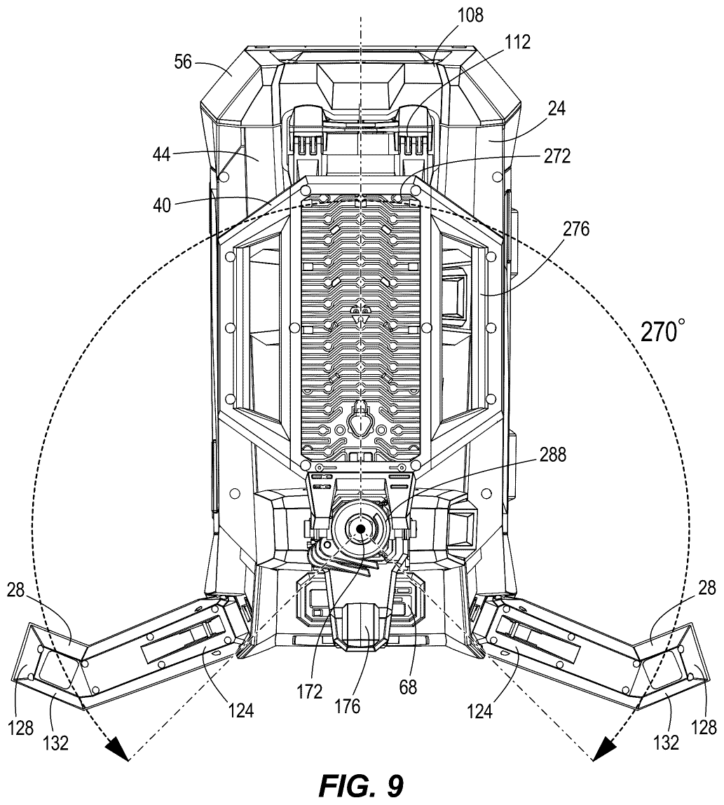

The legs 28 are rotatably connected to the base 24 and are rotatable between the stowed configuration where the legs 28 are positioned along the sides 60 of the base 24 and the open configuration where the distal ends 128 of the legs 28 are rotated away from the base 24. When in the stowed configuration, as shown in FIG. 8, the legs 28 are generally parallel to one another and are recessed within the perimeter of the base 24 to form a compact light. As shown in FIGS. 2 and 9, when the legs 28 are rotated to the open configuration, the legs 28 are oriented at an angle relative to one another. In other words, the proximal ends 124 of the legs 28 are closer together than the distal ends 128 when in the open configuration.

When the legs 28 are in the open configuration, the base 24 and the legs 28 form a wide base configuration for supporting the light body 32. In this configuration, the feet 132 on the distal ends 128 of the legs 28 contact the ground. The feet 132 are angled with respect to the rest of the legs 28 to provide better contact with the ground. The base 24 forms the third leg or support with the bottom end 48 contacting the ground. In this position, the base 24 is supported generally parallel with respect to the ground. The bottom end 48 may include additional features that function as base feet 136 to support the base 24 on the ground.

With reference to FIG. 5, the bottom end 48 of the base 24 includes a set of engaging features 140. The engaging features 140 interface with a system of components to mount the work light 20 to one of the components. For example, the engaging features 140 may be cleats that are received in recesses positioned on a tool case, a storage container, or another storage component. One example of such a system is the PACKOUT™ System by Milwaukee Tool®. In other embodiments, the engaging features 140 may be formed differently to interface with a different system. In some embodiments, the base feet 136 may be part of the set of engaging features 140 and in some embodiments the engaging features 140 may function as base feet 136 to support the base 24 on the ground.

Referring to FIGS. 1-3, the light body 32 is also capable of rotating between multiple positions relative to the base 24. The light body 32 is rotatably connected to the top end 44 of the base 24 by a rotation mechanism 144 for rotation about a rotation axis 148 between the stowed configuration and the open configuration. The light body 32 is selectively secured in the open configuration by a first latch assembly 152 and selectively secured in the closed configuration by second latch assembly 156.

As discussed previously, the light body 32 includes the mast 36 and the light head 40. In the illustrated embodiment, the mast 36 is a telescoping mast including a plurality of telescoping members 160 and extends between a first end 164 and a second end 168. The plurality of telescoping members 160 are translated along a mast axis 172 relative to each other so that the mast 36 can be extended (FIG. 3) and retracted (FIG. 2) to create different mast heights. Each telescoping member 160 has a generally rectangular cross section and is elongated along the mast axis 172. In other words, when viewed along the mast axis 172 the telescoping member 160 appears rectangular. In the illustrated embodiment the telescoping members 160 have a generally square cross section. The illustrated embodiment includes five of the telescoping members 160; however, in other embodiments more or fewer of the telescoping members 160 may be used. The telescoping members 160 are stowed concentrically to one another into a compact configuration, with each telescoping member 160 nested in a hollow portion of the telescoping member 160 adjacent thereto. As shown in FIG. 1, the outermost telescoping member 160 is rotatably coupled to the base 24 at the first end 164 of the mast 36 and the innermost telescoping member 160 is coupled to the light head 40 at the second end 168 of the mast 36. A handle 176 is coupled to the mast 36 adjacent the first end 164. When the work light 20 is in the stowed configuration, the handle 176 allows an operator to transport (e.g., carry) the work light 20 with the bottom end 48 facing downward towards the ground. The handle 176 also allows the operator to lift and rotate the light body 32 to the open configuration.

When in the open configurations, the mast 36 extends generally perpendicular to the longitudinal axis 64 of the base 24. When the base 24 is supported on the ground, the mast axis 172 may be generally vertical.

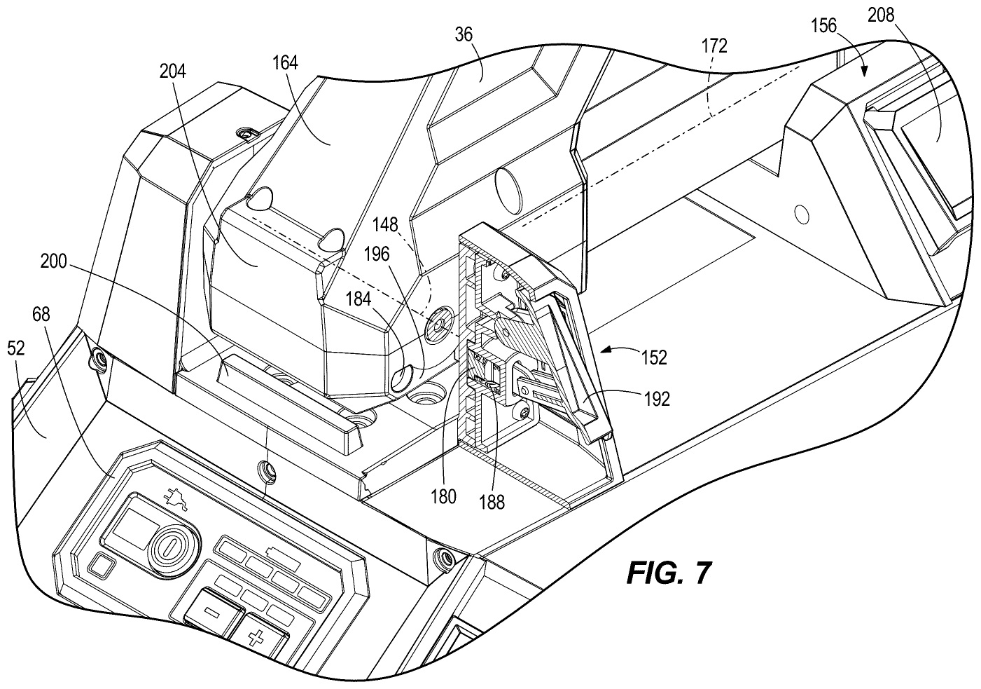

With reference to FIG. 7, and as mentioned above, the light body 32 is secured or retained in the upright position by the first latch assembly 152. The first latch assembly 152 is positioned on the top end 44 of the base 24. The first latch assembly 152 includes a plunger 180 that selectively engages an opening 184 on the mast 36. The opening 184 is spaced from the rotation axis 148 so that when the plunger 180 is received in the opening 184 the mast 36 is prevented from rotating about the rotation axis 148. The plunger 180 may be biased into engagement with the mast 36 by a biasing member 188. To release the mast 36, the operator may pull a lever tab 192 coupled to the plunger 180 to overcome the force of the biasing member 188 and remove the plunger 180 from the opening 184. When the mast 36 rotates away from the upright position, the plunger 180 follows an arcuate track or groove 196 on the mast 36 adjacent the opening 184, until the mast 36 is once again moved to the upright position.

While the first latch assembly 152 successfully secures the mast 36 in the upright position, there is inevitably some slack between the plunger 180 and the opening 184 due to tolerance requirements. This slack can cause the mast 36 to wobble or sway relative to the base 24, or other unstable behavior in the upright position, especially in environments with high winds. The work light 20 includes an isolating member 200 (or stop member 200) positioned on the top end 44 of the base 24. In the illustrated embodiment, the stop member 200 is a resilient rubber pad. In other embodiments, other types of biasing or isolating members may be used. The mast 36 may include a lower surface 204 that is positioned adjacent the top end 44 of the base 24 when the light body 32 is moved to the upright position. The stop member 200 is positioned on the surface of the top end 44 of the base 24 to push up against the lower surface 204 of the mast 36 and bias the mast 36 toward the stowed position. The biasing force of the stop member 200 pushes the mast 36 such that the plunger 180 of the first latch assembly 152 is held against a side of the opening 184 and the slack is removed. When the mast 36 is locked in the open position, the mast 36 is therefore supported between the stop member 200 and the first latch assembly 152 to reduce wobbling or swaying of the light body 32 and to improve stability of the mast 36.

With reference to FIG. 4, the light body 32 is secured in the stowed configuration by a second latch assembly 156 positioned on the top end 44 of the base 24. The second latch assembly 156 operates similar to the first latch assembly 152 and includes a lever tab 208 and a plunger (not shown). The lever tab 208 controls the plunger to selectively engage an opening 212. The opening 212 is positioned the mast 36 between the first end 164 and the second end 168.

When in the stowed configuration (FIG. 1), the mast 36 extends along the top end 44 of the base 24 between the front 52 and the back 56 and the light head 40 extends down along the back 56 toward the bottom end 48. When the light head 40 is in the stowed configuration, the light head 40 is oriented such that light emitted from a light source 216 within the light head 40 is directed toward the battery compartment 96. In some embodiments, the operator may select to store or transport the light 20 with the light head 40 in a different position. For example, in one embodiment, the light head 40 may be positioned so that light from the light source 216 may emit light forward, away from the base 24, and the light 20 may be operated to provide light during transport (e.g., similar to a flashlight or other directional lighting device).

As discussed above, the plurality of telescoping members 160 translate along a mast axis 172 relative to each other so that the mast 36 can be extended (FIG. 3) and retracted (FIG. 2) to create different mast heights. The telescoping members 160 each include an adjustment assembly 220 (also referred to herein as an adjustment mechanism 220) that selectively locks the position of the mast 36 and sets a mast height. The adjustment mechanism 220 is discussed in the context of locking an outer pole 224 with respect to an inner pole 228. The outer pole 224 may refer to any of the four telescoping members 160 surrounding the innermost telescoping member 160; the inner pole 228 refers to the adjacent telescoping member 160 within the outer pole 224.

With reference to FIG. 8, the adjustment mechanism 220 include an inner cuff 232, an outer cuff 236, and a latch 240 rotatably connected to the outer cuff 236. The inner cuff 232 and outer cuff 236 have rectangular profiles, for example, generally square profiles. The profiles of the inner cuff 232 and outer cuff 236 match the profiles of the telescoping members 160. The outer cuff 236 is coupled to the outer pole 224. The inner cuff 232 is positioned within the outer cuff 236 to selectively secure the inner pole 228 with respect to the adjustment mechanism 220 and the outer pole 224.

The outer cuff 236 includes a pair of side members 244 and a rear member 248. The side members 244 are coupled to either end of the rear member 248 by pins so that the side members 244 rotate about the respective pins. Each side member 244 includes a lower flange 252 and an upper flange 256. The side members 244 are rotated so that the respective flanges 252, 256 are adjacent each other and generally opposite the rear member 248. A slot 260 is formed in each side member 244 between the flanges 252, 256 so that clamping movement of an upper portion 264 of the outer cuff 236 and a lower portion 268 of the outer cuff 236 are partially isolated from each other.

A fastener (not shown) is coupled to the lower flanges 252 of each side member 244. The fastener is tightened to move the lower flanges 252 toward each other to clamp the lower portion 268 of the outer cuff 236 inward. The lower portion 268 of the outer cuff 236 surrounds an upper end of the outer pole 224 and the adjustment mechanism 220 is secured to the outer pole 224. In some embodiments, alternate or additional methods may be used to secure the outer cuff 236 to the outer pole 224 (e.g., adhesive, etc.). The latch 240 is coupled to the upper flanges 256 of each side member 244. The latch 240 is a cam latch or cam lever so that rotation of the latch 240 toward the outer cuff 236 clamps the upper portion 264 of the outer cuff 236 and rotation of the latch 240 away from the outer cuff 236 releases the outer cuff 236. In some embodiments a biasing member may bias the latch 240 towards or away from the outer cuff 236. As mentioned above, the inner cuff 232 is positioned within the outer cuff 236 adjacent the inner pole 228. When the upper portion 264 of the outer cuff 236 is clamped by the latch 240, the inner cuff 232 is biased into engagement with the inner pole 228, preventing translation of the inner pole 228. The rectangular profile of the telescoping members 160 and of the adjustment mechanisms 220 prevents the telescoping members 160 from rotating about the mast axis 172. The adjustment mechanisms 220 are used to vary the height of the light head 40 with respect to the base 24 (e.g., adjust the light head 40 in a linear direction).

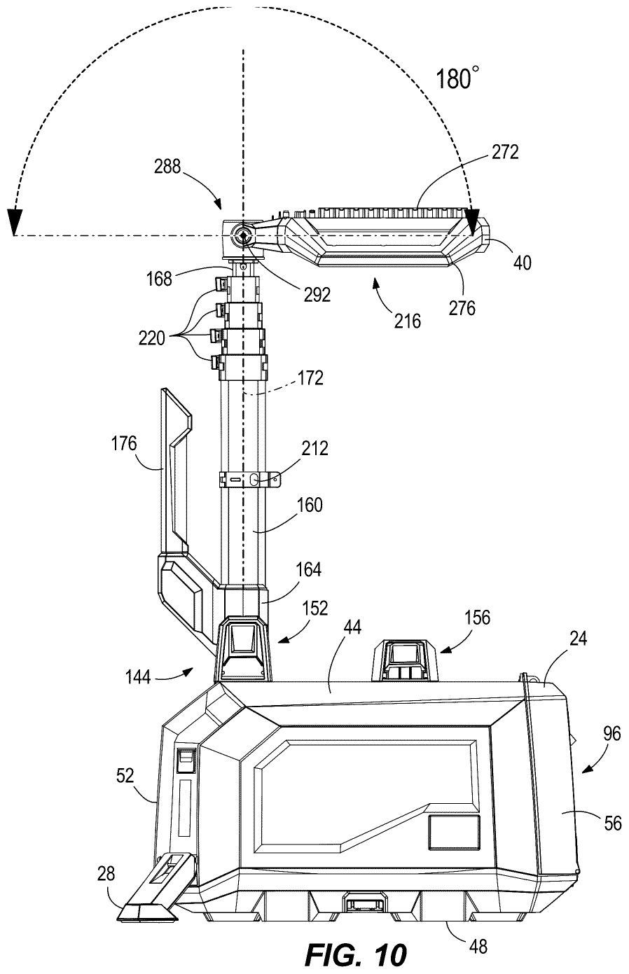

With reference to FIGS. 9 and 10, the light head 40 includes the light source 216, a heat sink 272, a pair of handles 276, and a lens 280 (FIG. 1). In the illustrated embodiment, the light source 216 is an array of light emitting diodes (LEDs) 284. In other embodiments, other types of light sources may be used. The handles 276 may be engaged by an operator to adjust the light head 40 to various orientations to direct light in various directions (i.e., adjust the light head 40 in a rotational direction). The light head 40 is rotatably connected to the mast 36 by a hinge assembly 288. With reference to FIG. 9, the hinge assembly 288 allows the light head 40 to rotate about the mast axis 172. The light head 40 is rotatable about the mast axis 172 about 270 degrees. In the illustrated embodiment, the 270 degree range overlies the base 24 and legs 28. As seen in FIG. 10, the light head 40 also pivots about a pivot axis 292 that is perpendicular to the mast axis 172. The light head 40 is pivotable about the pivot axis 292 about 180 degrees. Thus, when the mast axis 172 is generally vertical, the light head 40 is movable between a position in which the light source 216 faces directly downward and a position in which the light source 216 faces directly upward, through the positions in between in which the light source 216 is angled with respect to the ground.

The work light 20 is used to provide light to an area, especially a worksite. With some known lighting configurations, a light source may be configured to emit all the light in generally the same direction creating a narrow light distribution pattern (e.g., spot lighting). This can be less than ideal in a worksite environment because work is typically occurring in an area larger than what is covered by a typical spotlight, especially a spotlight at the heights reached by known portable lights. In other known lighting configurations, a light source may be configured to emit light in a wide range of directions, creating a dispersed light distribution pattern. However, this can be inefficient in some worksites because a portion of light is emitted in directions with no work occurring (e.g., laterally and upwards) and thus light is lost, making the light less efficient at illuminating the worksite.

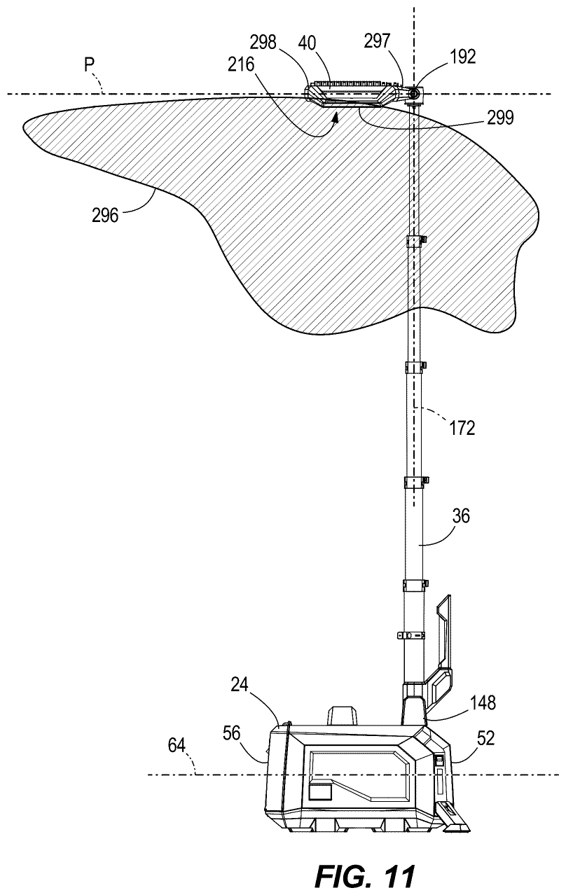

As seen in FIGS. 11-13, the light source 216 and lens 280 of the work light 20 provide a light distribution pattern 296 to emit light within an active working area adjacent the work light 20. The light head 40 extends between a first end 297, coupled to the mast 36, and a second end 298, extending away from the mast 36. The light head 40 is therefore supported on the mast 36 in a cantilevered fashion. The light source is positioned on a surface 299 between the first end 297 and the second end 298. The light distribution pattern 296 is described with reference to the light head 40 being positioned generally level or horizontal, with the surface 299 facing down toward the ground, and with the light head 40 directly over the base 24. The light head 40 defines a plane P, and in the illustrated configuration, the plane P is parallel to the ground and perpendicular to the mast axis 172. In this position, the emitted light distribution pattern 296 is similar to that of a streetlight and emits light “downward” and “forward” of the light head 40. As best seen in FIG. 11, in the light distribution pattern 296 all of the light is emitted below the plane P. This decreases the amount of light that is wasted by emitting away from the active work area. In the illustrated embodiment, more than 50% of the light is distributed within the active working area. In some embodiments, more than 90% of the light is distributed within the active working area. In the light distribution pattern 296, more light is emitted past the second end 298 of the light head 40 than the first end 297 of the light head 40. In other words, more light is emitted away from the mast 36 than toward the mast 36. With the light head 40 in the illustrated position, this results in more light being emitted toward the back 56 or second end 56 of the base 24.

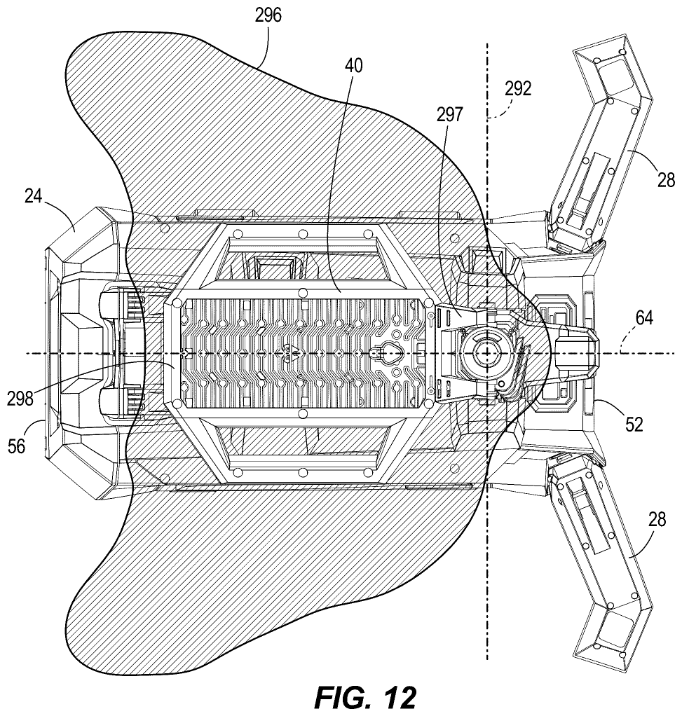

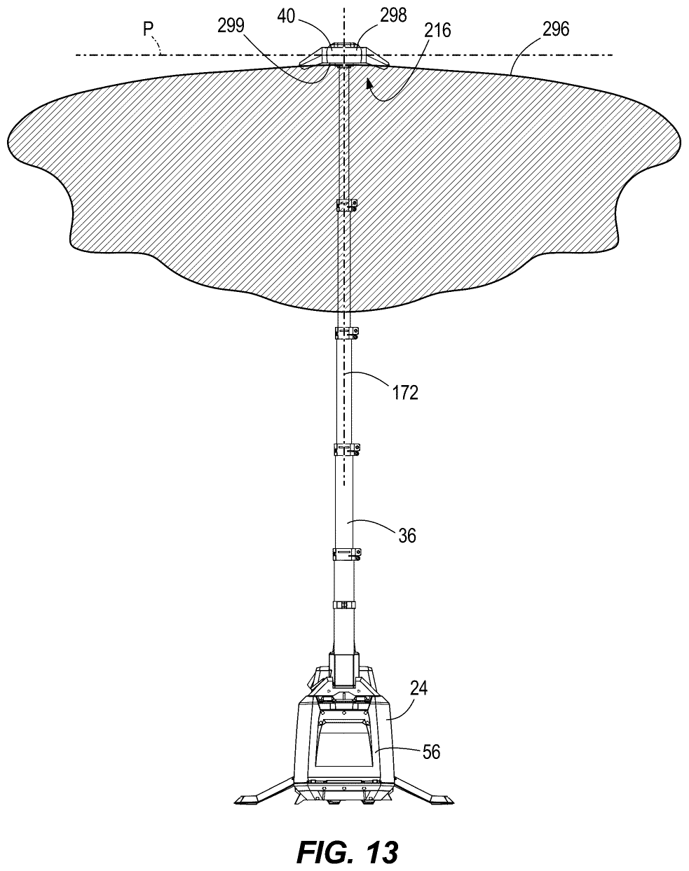

FIG. 11 illustrates the light distribution pattern 296 from a side of the work light 20 (perpendicular to the longitudinal axis 64 of the base 24). As discussed, the mast 36 is in the upright position and the light head 40 is oriented with the light source 216 facing directly toward the ground. More light is emitted “forward” of the light head 40, toward the second end 56 of the base, than “rearward,” toward the first end 52 of the base. In the illustrated open configuration, “forward” is along the longitudinal axis 64 of the base 24 toward the back 56 and “rearward” is along the longitudinal axis 64 past the front 52 of the base 24. In the illustrated open configuration, “downward” is along the mast axis 172 toward the ground. With reference to FIGS. 12 and 13, the light distribution pattern 296 emits light evenly to either side of the light head 40. In some embodiments, this light distribution pattern 296 may be electronically controllable and is one of many light modes selectable by the operator via the user interface 68. In other embodiments, the light distribution pattern 296 is created by fixed components of the light head 40 and cannot be adjusted.

In operation, an operator transports the work light 20 to a worksite with the work light 20 in a compact stowed configuration, as shown in FIG. 1. When the work light 20 is in the stowed configuration, the legs 28 are positioned in the stowed configuration within the leg cradles 116 on the sides 60 of the base 24. The light body 32 is locked in the stowed configuration by the second latch assembly 156, with the mast 36 extending parallel to the longitudinal axis 64, and the light head 40 extending down across the battery compartment 96. The telescoping mast 36 is retracted. The operator may carry the work light 20 using the handle 176 coupled to the mast 36 on the top end 44 of the work light 20. Alternately, the operator may couple the work light 20 to a storage system and transport the entire system to the worksite.

Once at the worksite, an operator may expand the work light 20 into one of the open configurations. To do this, an operator deploys the legs 28 by accessing the legs 28 through the notches 120 and rotating the legs 28 outward so the feet 132 are in contact with the ground. The operator moves the light body 32 to the open configuration by first pulling the lever tab 208 to release the mast 36, then lifting with the handle 176 to rotate the light body 32 about the rotation axis 148 until the mast axis 172 is approximately vertical. As the light body 32 rotates to the upright position, the plunger 180 of the first latch assembly 152 follows the arcuate track 196 until the plunger 180 aligns with the opening 184 on the mast 36 and the biasing member 188 biases the plunger 180 into the opening 184. The light body 32 is locked by the first latch assembly 152 in the open configuration. The stop member 200 presses against the lower surface 204 to bias the mast 36 toward the stowed position to reduce wobble or sway of the light body 32 in the upright position.

The operator then extends the mast 36 until the light head 40 reaches the desired height. The mast 36 is extended by translating the telescoping members 160 along the mast axis 172. As needed, the adjustment mechanisms 220 are opened and closed to selectively lock the telescoping members 160. For example, the latch 240 is pivoted away from the outer cuff 236 so the upper portion 264 of the outer cuff 236 loosens, allowing the telescoping member 160 positioned inside the inner cuff 232 to slide. The latch 240 is then pivoted toward the outer cuff 236 to clamp the inner cuff 232 against the inner pole 228 to lock the telescoping member 160 and set the mast height.

The operator may rotate the light head 40 about the mast axis 172 and the pivot axis 292 as needed, before, during, or after the mast 36 is extended. The operator may rotate the light head 40 using the handles 276. Once the light head 40 and mast 36 are positioned as desired, if needed, the battery 100 or the power cord 80 is connected to the work light 20 to provide power to the light source 216. Once the power has been connected to the work light 20, the operator may control the light source 216 using the user interface 68.

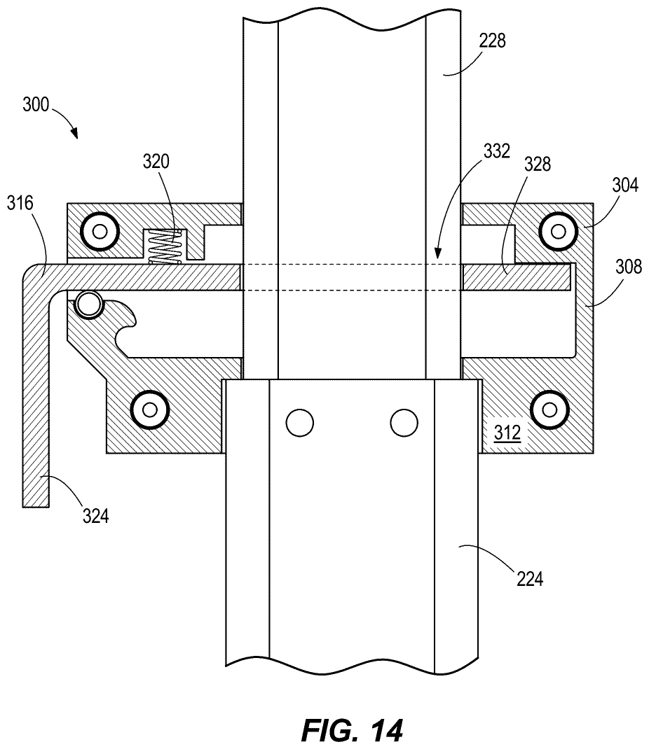

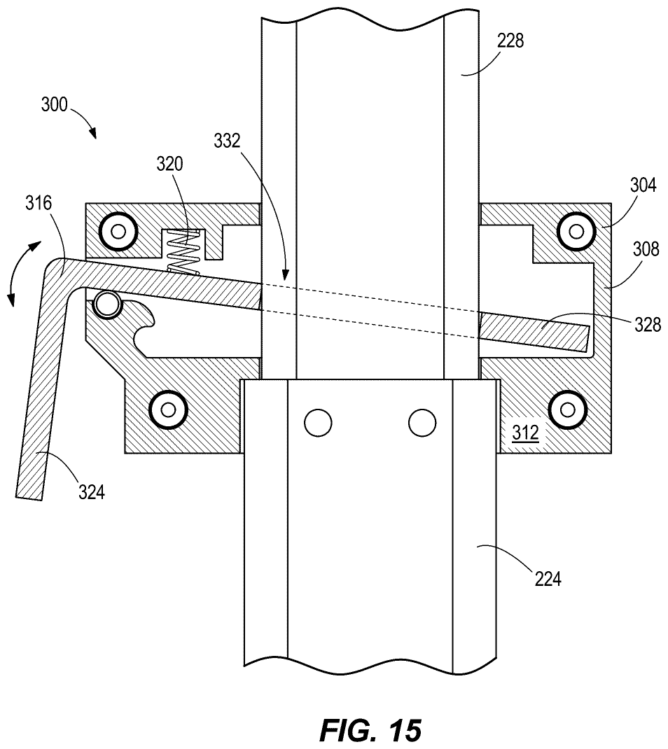

FIGS. 14-15 illustrate an alternate adjustment mechanism 300 that may be used in place of the adjustment mechanisms 220 to secure the telescoping members 160 of the mast 36 relative to each other. The adjustment mechanism 300 is discussed with reference to the outer pole 224 and inner pole 228, similar to the adjustment mechanism 220. The adjustment mechanism 300 includes a cuff 304 having an upper portion 308 and a lower portion 312. The lower portion 312 of the cuff 304 surrounds and is coupled to the outer pole 224. The upper portion 264 of the cuff 304 extends past the end of the outer pole 224 to surround the inner pole 228. A pivoting latch 316 (also referred to herein as a friction lever) is coupled to the cuff 304 and is rotatable with respect to the cuff 304 between an unlocked position (FIG. 15) and a locked position (FIG. 14). The latch 316 rotates about an axis perpendicular to the mast axis 172. The latch 316 is biased toward the locked position by a biasing member 320. In the illustrated embodiment the biasing member 320 is a linear spring positioned between the latch 316 and an upper wall of the cuff 304. The latch 316 includes a first arm 324 and a second arm 328 having an opening 332. The latch 316 is coupled to the cuff 304 so that the first arm 324 extends outside of the cuff 304 and the second arm 328 extends within the cuff 304 with the opening 332 surrounding the inner pole 228. When the latch 316 is in the unlocked position, the second arm 328 extends perpendicular to the mast axis 172. The opening 332 forms a pathway that is large enough for the inner pole 228 to translate along the mast axis 172 with respect to the outer pole 224. When the latch 316 is in the locked position, the second arm 328 is angled with respect to the mast axis 172, reducing the size of the pathway created by the opening 332. Thus, the second arm 328 engages the inner pole 228 to prevent movement along the mast axis 172.

In operation, the mast 36 is extended by moving the inner pole 228 upward (i.e., in a first direction) along the mast axis 172 relative to the outer pole 224. An operator may lift the inner pole 228 in the first direction without manually releasing the adjustment mechanism 300. As the operator lifts, force is applied to the inner pole 228 and as the inner pole 228 translates in the first direction along the mast axis 172, the friction between the second arm 328 and the inner pole 228 raises the latch 316 into the unlocked position. Once the inner pole 228 has been extended, the operator releases the inner pole 228, allowing gravity to act on the inner pole 228 and move it downward (i.e., in a second direction). The movement of the inner pole 228 in the second direction and the friction between the second arm 328 and the inner pole 228, as well as the biasing force applied by the biasing member 320, cooperate to move the latch 316 to the locked position, securing the mast 36 in the extended position.

To collapse the mast 36, the inner pole 228 retracts downward along the mast axis 172 into the outer pole 224. To release the inner pole 228, the operator manually releases the adjustment mechanism 300 by pushes on the first arm 324 of the latch 316, overcoming the friction between the inner pole 228 and the second arm 328 and overcoming the force of the biasing member 320 to move the latch 316 to the unlocked position. The operator holds the latch 316 in the unlocked position and the inner pole 228 is then free to translate downward (i.e., in the second direction) along the mast axis 172. The operator may release the latch 316 to secure the inner pole 228 at the new position.

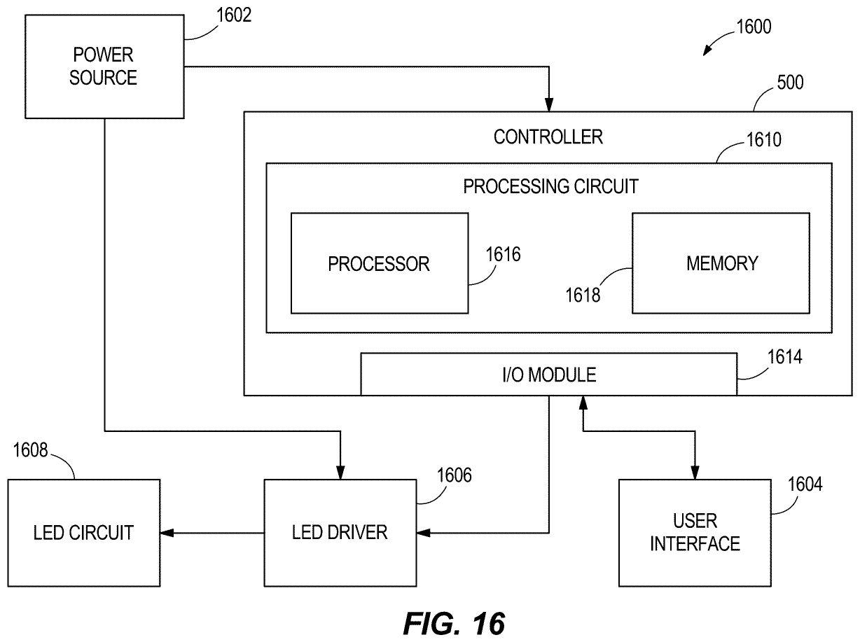

Turning now to FIG. 16, a block diagram of a control system 1600 of the work light 20 is shown, according to some embodiments. The control system 1600 may include a controller, such as controller 500, described above. The control system 1600 further includes a power source 1602, a user interface 1604, an LED driver 1606, and an LED circuit 1608. The controller 500 may include a processing circuit 1610, and an input-output (“I/O”) module 1614.

The power source 1602 may be a renewable power source, such as a battery (e.g., similar to battery 100). However, in other embodiments, the power source may be powered by a utility service (e.g., via an AC input), or a constant power source (e.g., external DC power supply) (e.g., by power cord 80). In one example, the power source 1602 may be a rechargeable battery, such as a lithium-ion battery, a lithium-iron phosphate battery, etc. In some examples, the rechargeable battery might be a rechargeable power tool battery. The power source 1602 shown in FIG. 16 may be an 18 VDC battery, a 40 VDC battery, and/or other battery voltage as required for a given application. The power source 1602 may provide power to the various components of the control system 1600, such as the controller 500, and the LED driver 1606.

The controller 500 includes the processing circuit 1610. The processing circuit 1610 may include one or more electronic processors 1616 as well as a memory device 1618. The electronic processors 1616 may be communicably connected to one or more of the user interface 1604, the LED driver 1606, etc. The electronic processors 1616 may be implemented as a programmable microprocessor, an application specific integrated circuit (“ASIC”), one or more field programmable gate arrays (“FPGA”), a group of processing components, or with other suitable electronic processing components.

The memory device 1618 (for example, a non-transitory, computer-readable medium) includes one or more devices (for example, RAM, ROM, flash memory, hard disk storage, etc.) for storing data and/or computer code for completing or facilitating the various processes, layers, and modules described herein. The memory device 1618 may include database components, object code components, script components, or other types of code and information for supporting the various activities and information structure described in the present application. According to one example, the memory device 1618 is communicably connected to the electronic processor 1616 via the processing circuit 1610 and may include computer code for executing (for example, by the processing circuit 1610 and/or the electronic processor 1616) one or more processes described herein. The I/O module 1614 may be configured to interface directly with one or more devices, such as a power supply, a power monitor, etc. In one embodiment, the I/O module 1614 may utilize general purpose I/O (GPIO) ports, analog inputs, digital inputs, etc.

The user interface 1604 may be similar to the user interface 68 described above, and may include various controls described above, including a brightness control. The brightness control may provide a signal to the controller 500 via the I/O module 1614. The controller 500, such as via the processing circuit 1610 may be configured to receive a signal from the user interface 1604 indicating a desired brightness of the of the LED circuit 1608. In one embodiment, the LED circuit 1608 may include one or more LEDs, such as those described above. Furthermore, the LED circuit 1608 may be used interchangeably with the light source 216, described herein.

The controller 500 may then provide an output to the LED driver 1606 indicative of a desired brightness of the LED circuit 1608. In one embodiment, the LED driver 1606 may be configured to control the brightness of the LED circuit 1608 using an analog signal. By utilizing an analog signal in lieu of a more typical pulse-width modulation (“PWM”) or digital signal, stroboscopic effect is reduced as a constant DC current is applied to the one or more LEDs within the LED circuit 1608 as opposed to a switched current in a PWM based system. Further, as PWM switching relies on high-speed switching to control the output of the LEDs within the LED circuit 1608, there may typically be an audible noise that emanates from the LED circuit 1608 due to the switching current. This noise is substantially reduced in an analog dimming system as a constant current is used to control the brightness of the LEDs of the LED circuit 1608. Furthermore, due to reduction in peak currents that occur when using PWM based dimming system, power efficiency is improved when using an analog dimming system as opposed to a PWM based dimming system. Finally, analog based dimming systems have lower radiated emissions due to the elimination of reduction of switching required to control the brightness levels of the associated LEDs. However, in other examples, a PWM control system may be used to control the brightness of the LED circuit 1608.

In one embodiment, the LED driver 1606 is an MP24830 from MPS®. However, other LED driver circuits/devices are also contemplated as required for given application. In one embodiment, the controller 500 may provide an input to the LED driver 1606 to control whether the dimming of the LED circuit 1608 is to be analog dimming or PWM dimming. For example, the controller 500 may provide a signal to pin 5 of the LED driver 1606 to control the dimming mode. The LED driver 1606 is then configured to generate an output to the LED circuit 1608 to control the output of the LEDs of the LED circuit 1608. As noted above, in one embodiment, the output signal is an analog dimming signal. In one embodiment, the output signal is a variable analog current signal. In other embodiments, the output signal is a variable analog voltage signal. In still other examples, the output signal is one or more of an analog current signal and an analog voltage signal.

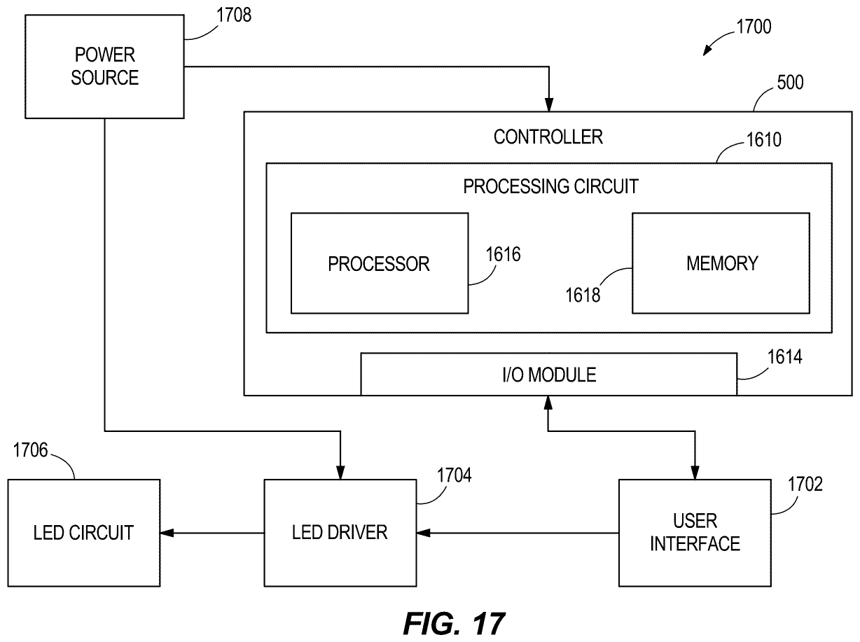

Turning now to FIG. 17, an alternative control circuit 1700 is shown, according to some embodiments. In the example of FIG. 17, a user interface 1702 is coupled directly to the LED driver 1704 to control dimming of an associated LED circuit 1706. In the example of FIG. 17, the user interface 1702 may be similar to user interface 1604, described above. Furthermore, the LED driver 1704 similar to the LED driver 1606 described above. A power source 1708 may be coupled to the LED driver 1704 to provide power to the LED circuit 1706. The power source 1708 may be similar to the power source 1602 described above. The control circuit 1700 may further include the controller 500 described above for controlling other aspects the work light 20.

In one example, the user interface 1702 may include various circuitry, such as an RC circuit, and RLC circuit, a variable resistor circuit, or various digital circuitry to generate a dimming signal based on a user input (e.g., such as via a button, knob, dial, digital interface, etc.) which is then provided to the LED driver 1704. The LED driver 1704 is then configured to control the illumination output of the LED circuit 1706 based on the received dimming signal.

The above examples are illustrative in nature, and it is understood that other analog dimming circuits for dimming an LED circuit such as LEDs used in the light source 216 or other lighting devices described herein are also contemplated as required for a given application.

Accordingly, the invention provides an area light that is easily transported in a compact configuration and the light can be adjusted to different heights via the telescoping members and directed in different directions via the hinges.

The embodiment described above and illustrated in the figures are presented by way of example only and are not intended as a limitation upon the concepts and principles of the present invention. As such, it will be appreciated that various changes in the elements and their configuration and arrangement are possible without departing from the spirit and scope of the present invention. Various features and advantages of the invention are set forth in the following claims.

What is claimed is:

1. An area light, comprising:
a base having a first end, a second end, and a top end and a bottom end extending between the first end and the second end;
a pair of legs rotatably coupled to the first end of the base adjacent the bottom end, wherein the pair of legs are rotated towards the base when the area light is in a stowed configuration and are rotated away from the base when the area light is in an open configuration; and
a light body having a mast and a light head coupled to the mast, the light body being rotatably coupled to the top end adjacent the first end of the base, wherein the light body is rotated towards the base when the area light is in the stowed configuration and is rotated away from the base when the area light is in the open configuration;
wherein in the stowed configuration the pair of legs extend toward the top end.

2. The area light of claim 1, wherein the mast includes a plurality of telescoping members configured to extend and retract the mast along a mast axis, wherein each telescoping member of the plurality of telescoping members has an adjustment assembly configured to selectively lock the telescoping member to an adjacent telescoping member, and wherein each telescoping member has a rectangular profile when viewed along the mast axis.

3. The area light of claim 2, wherein the adjustment assembly includes a cuff and a friction lever rotatably coupled to the cuff between a locked position and an unlocked position, wherein in the locked position the adjustment assembly prevents the adjacent telescoping member from moving with respect to the adjustment assembly.

4. The area light of claim 1, wherein the mast extends along a mast axis between a first end and a second end, and wherein the light body further includes a handle positioned adjacent the first end and extending generally parallel to the mast axis.

5. The area light of claim 1, wherein the base includes a pair of leg cradles, wherein each leg is rotatably coupled to the base adjacent an associated leg cradle, and wherein in the stowed configuration each of the pair of legs are received by the associated leg cradle and fit within a footprint of the base.

6. The area light of claim 5, wherein each leg includes a proximal end coupled to the associated leg cradle and a distal end having a foot configured to engage a surface in the open configuration.

7. The area light of claim 6, wherein in the stowed configuration the pair of legs are approximately parallel to each other, and wherein in the open configuration the pair of legs are angled with respect to each other such that a distance between each of the distal ends is greater than the distance between each of the proximal ends and the pair of legs create a wide base.

8. An area light configured to provide light to an active working area, comprising:
a base extending between a first end and a second end;
a pair of legs coupled to the first end of the base for movement between an open configuration and a stowed configuration;
a mast coupled to the first end of the base, the mast including a plurality of telescoping members configured to extend and retract the mast along a mast axis; and
a light head extending along a plane between a first head end coupled to the mast, and a second head end, wherein the light head includes a light source configured to emit light in a light distribution pattern, wherein in the light distribution pattern all the light is distributed below the plane and more than 50% of the light is distributed within the active working area.

9. The area light of claim 8, wherein in the light distribution pattern more light is distributed past the second head end of the light head than past the first head end.

10. The area light of claim 8, wherein in the light distribution pattern, more than 50% of the light is distributed in front of the light head, away from the mast.

11. The area light of claim 8, wherein the light head is positioned with the second head end directly above the base and more of the light of the light distribution pattern is distributed toward the second end of the base than toward the first end of the base.

12. The area light of claim 8, further comprising a light driver module configured to control the light source, wherein the light driver module controls a brightness of the light source using analog current control.

13. The area light of claim 12, further comprising a user interface configured to receive an input indicating a desired brightness and generate a brightness output associated with received input.

14. The area light of claim 13, further comprising an analog control circuit configured to:
receive the brightness output;
generate a brightness control signal based on the received brightness output; and
provide the generated brightness control signal to the light driver module.

15. The area light of claim 14, wherein the analog control circuit is an RC circuit.

16. The area light of claim 14, wherein the analog current control uses a DC current to control the brightness of the light source.

17. An area light, comprising:
a base;
a pair of legs coupled to the base, wherein the legs are each positioned adjacent the base when the area light is in a stowed configuration and the legs each extend away from the base when the area light is in an open configuration;
a light body having a mast and a light head coupled to the mast, the light body being rotatably coupled to a top surface of the base, wherein the light body is rotated towards the base when the area light is in the stowed configuration and is rotated away from the base when the area light is in the open configuration;
a latch assembly configured to retain the light body in the open configuration; and
a stop member that biases the mast toward the stowed configuration;
wherein in the open configuration the mast is secured between the stop member and the latch assembly to improve stability of the mast.

18. The area light of claim 17, wherein the stop member is a resilient pad positioned on the top surface of the base and engages a lower surface of the mast to bias the mast toward the stowed configuration.

19. The area light of claim 17, wherein the light body rotates about a rotation axis and the latch assembly is spaced from the rotation axis, the latch assembly including a plunger that selectively engages an opening in the mast to prevent rotation of the light body relative to the base, wherein the plunger is narrower than the opening and movable perpendicular to the rotation axis.

20. The area light of claim 19, wherein the stop member is coupled to the base and is spaced from the rotation axis, wherein the stop member is configured to engage the mast to bias the mast toward the stowed configuration, and wherein the stop member biases the mast such that the plunger is held against a side of the opening.
